(19) United States
(12) Patent Application Publication
(10) Pub. No.: US 2010/0092788 A1
(43) Pub. Date: Apr. 15, 2010

(54) BONDING METHOD AND BONDED BODY

(75) Inventors: Nobuhiro NAITO, Chino (JP); Mitsuru SATO, Suwa (JP); Takatoshi YAMAMOTO, Suwa (JP); Minehiro IMAMURA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/577,266

(22) Filed: Oct. 12, 2009

(30) Foreign Application Priority Data
Oct. 15, 2008 (JP) 2008-266672

(51) Int. Cl. B32B 27/00; B32B 37/06

(52) U.S. Cl. 428/447; 156/273.3

(57) ABSTRACT

A bonding method includes: a) applying a liquid material containing a silicone material to at least one of the first base member and the second base member so as to form a liquid film on the at least one of the base members; b) drying the liquid film so as to obtain the bonding film on the at least one of the first base member and the second base member; c) bringing plasma into contact with the bonding film so as to develop adhesiveness around a surface of the bonding film; and d) bringing the first base member and the second base member into contact with each other in a manner to interpose the bonding film on which adhesiveness is developed therebetween so as to obtain a bonded body in which the first base member and the second base member are bonded to each other with the bonding film interposed therebetween.

The entire disclosure of Japanese Patent Application No. 2008-266672, filed Oct. 15, 2008 is expressly incorporated by reference herein.

### BACKGROUND

1. Technical Field

The present invention relates to a bonding method and a bonded body.

2. Related Art

As a bonding method for bonding base members made of various materials, JP-A-2003-212613, JP-A-2007-130836, and JP-A-2008-19348, for example, disclose methods in which two base members are bonded to each other by irradiating a surface, which is a bonding face, of one of the base members with ultraviolet light.

However, the methods have the following problems: requiring one to dozens of minutes for the ultraviolet light irradiation; requiring dozens of minutes or more for press-bonding the two base members in a case where the ultraviolet light irradiation is performed in a short period of time; and requiring, in some cases, simultaneous performances of the ultraviolet light irradiation and the pressuring of the two base members.

In short, these methods require long time for bonding the two base members and include complicated operations.

### SUMMARY

An advantage of the present invention is to provide a bonding method in which two base members can be bonded to each other in a short period of time at low cost, and a bonded body formed by the bonding method.

This advantage is achieved by the following aspects of the invention.

A bonding method according to a first aspect of the invention includes: a) applying a liquid material containing a silicone material to at least one of the first base member and the second base member so as to form a liquid film on the at least one of the base members; b) drying the liquid film so as to obtain the bonding film on the at least one of the first base member and the second base member; c) bringing plasma into contact with the bonding film so as to develop adhesiveness around a surface of the bonding film; and d) bringing the first base member and the second base member into contact with each other in a manner to interpose the bonding film on which adhesiveness is developed therebetween so as to obtain a bonded body in which the first base member and the second base member are bonded to each other with the bonding film interposed therebetween.

By the method, the two base members can be bonded to each other in a short period of time at low cost.

In the bonding method of the aspect, it is preferable that the plasma contact of the step c) be performed in atmospheric pressure.

According to the plasma contact performed in the atmospheric pressure, that is, according to an atmospheric pressure plasma treatment, a surrounding area of the bonding film is not in a reduced pressure state. Therefore, when methyl groups included in a polydimethylsiloxane skeleton of the silicone material, for example, are cleaved and removed so as to develop adhesiveness around the surface of the bonding film, the plasma acts to prevent unwanted progress of the cleaving.

In the bonding method of the aspect, it is preferable that the plasma contact be performed such that a gas, which is converted into plasma by being introduced between electrodes opposed to each other in a state that a voltage is applied between the electrodes, is applied to the bonding film.

Accordingly, the plasma can be easily and reliably brought into contact with the bonding film so as to securely develop the adhesiveness around the surface of the bonding film.

In the bonding method of the aspect, it is preferable that a distance between the electrodes be from 0.5 mm to 10 mm inclusive.

Accordingly, an electric field can be more securely generated between the electrodes, whereby the adhesiveness can be reliably developed around the surface of the bonding film.

In the bonding method of the aspect, it is preferable that the voltage applied between the electrodes be from 1.0 kVp-p to 3.0 kVp-p inclusive.

Accordingly, the electric field can be more securely generated between the electrodes, whereby the adhesiveness can be reliably developed around the surface of the bonding film.

In the bonding method of the aspect, it is preferable that the plasma be obtained by converting a gas mainly containing a helium gas into plasma.

Accordingly, the degree of activation of the bonding film is easily controlled.

In the bonding method of the aspect, it is preferable that the plasma be obtained by converting the gas mainly containing the helium gas into plasma, and an applying speed of the gas between the electrodes be from 1 standard litter per minute (SLM) to 20 SLM inclusive.

When the plasma is brought into contact with the bonding film at the speed in such the range, the bonding film can be sufficiently and securely activated even in a short period of time.

In the bonding method of the aspect, it is preferable that a contained amount of the helium gas in the gas be 85 vol % or more.

Accordingly, an effect that the bonding film is activated by the plasma can be more markedly exerted.

In the bonding method of the aspect, it is preferable that the silicone material have a polydimethylsiloxane skeleton as a main skeleton.

Such the silicone material is easily available and inexpensive. In addition, the silicone material is preferably used because when energy is applied to the bonding film containing the material, methyl groups constituting the silicone material are easily cleaved and, as a result, the adhesiveness can be securely developed on the bonding film.

In the bonding method of the aspect, it is preferable that the silicone material include a silanol group.

Accordingly, when the liquid film is dried so as to obtain the bonding film, hydroxyl groups, which are adjacent to each other, included in the silanole group contained in the silicone material are bonded with each other. Therefore, the bonding film to be obtained has superior film strength.

In the bonding method of the aspect, it is preferable that an average thickness of the bonding film be 10 nm to 10,000 nm inclusive.

This can prevent significant degradation of dimensional accuracy of the bonded body obtained by bonding the first and second base members and can increase the bonding strength between the first and second base members.

In the bonding method of the aspect, it is preferable that at least a portion of the first base member and the second base member contacting with the bonding film be mainly made of one of a silicon material, a metal material, and a glass material.

Accordingly, sufficient bonding strength can be obtained even without performing any surface treatment.

In the bonding method of the aspect, it is preferable that a surface treatment be performed on surfaces, which are to be brought into contact with the bonding film, of the first base member and the second base member in advance so as to increase the adhesiveness with respect to the bonding film.

Bond surfaces of the base members are cleaned and activated due to the surface treatment, whereby the bonding film easily acts chemically on the bond surfaces. As a result, the bonding strength between the bond surfaces of the base members and the bonding film can be increased.

In the bonding method of the aspect, it is preferable that the surface treatment be one of a plasma treatment and an ultraviolet light irradiation treatment.

The surface treatment as above can particularly optimize the surface of the base member for forming the bonding film thereon.

A bonded body according to a second aspect of the invention is obtained by bonding the first base member and the second base member with the bonding film interposed therebetween by the bonding method of the first aspect.

Accordingly, a highly reliable bonded body can be obtained.

### BRIEF DESCRIPTION OF THE DRAWINGS

The invention will be described with reference to the accompanying drawings, wherein like numbers reference like elements.

FIGS. 1A to 1D are longitudinal sectional views for explaining a bonding method of a first embodiment of the invention.

FIGS. 2E to 2G are longitudinal sectional views for explaining the bonding method of the first embodiment of the invention.

FIG. 3 is a schematic view showing a structure of an atmospheric-pressure plasma apparatus.

FIGS. 4A to 4C are longitudinal sectional views for explaining a bonding method of a second embodiment of the invention.

FIG. 5 is an exploded perspective view showing an ink-jet type recording head (a droplet discharge head) obtained by applying a bonded body of the invention.

FIG. 6 is a sectional view showing a structure of a main part of the ink-jet type recording head of FIG. 5.

FIG. 7 is a schematic view showing an ink-jet printer including the ink-jet type recording head of FIG. 5.

FIG. 8 is a graph showing a relationship between UV irradiation time with respect to a bonding film and a changing rate of a film thickness.

### DESCRIPTION OF EXEMPLARY EMBODIMENTS

A bonding method and a bonded body of the invention will now be described in detail based on preferred embodiments with reference to the accompanying drawings.

Bonding Method

The bonding method of the invention includes the following steps: [1] preparing a first base member 21 and a second base member 22 that are to be bonded to each other with a bonding film interposed therebetween, [2] applying a liquid material containing a silicone material to at least one of the first base member 21 and the second base member 22 so as to form a liquid film 30, [3] drying the liquid film so as to form a bonding film 3 on at least one of the first base member 21 and the second base member 22, [4] bringing plasma into contact with the bonding film 3 so as to develop adhesiveness around a surface of the bonding film 3, and [5] bringing the first base member 21 into contact with the second base member 22 while interposing the bonding film 3, on which the adhesiveness is developed, so as to obtain a bonded body 1 in which the first base member 21 and the second base member 22 are bonded to each other with the bonding film 3 interposed.

Hereafter, the bonding method according to a first embodiment of the invention will be described by each step.

### First Embodiment

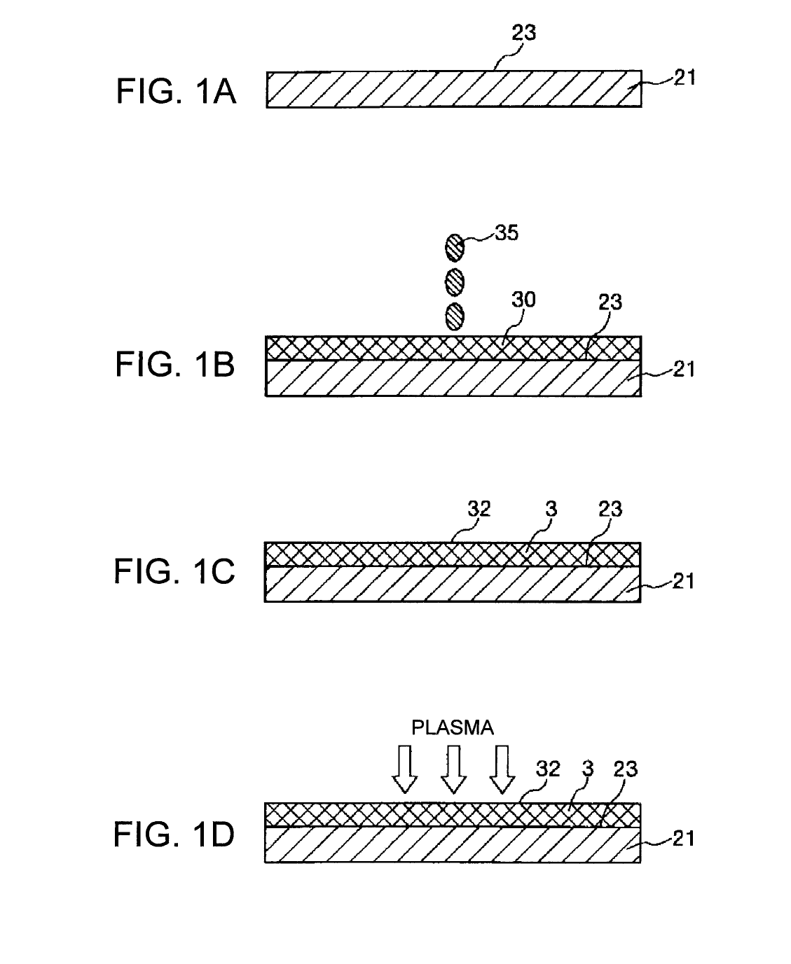

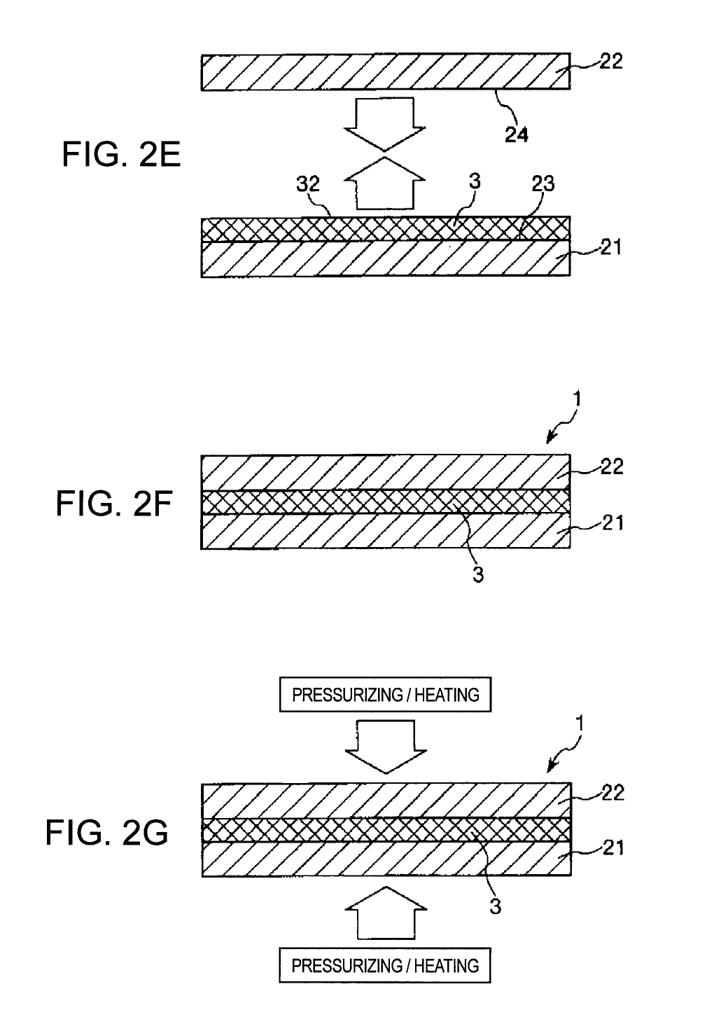

FIGS. 1A, 1B, 1C, 1D, 2E, 2F, and 2G are diagrams (longitudinal sectional views) for explaining the first embodiment exemplifying the bonding method of the invention. Here, an upper side of FIGS. 1A to 2G is referred to as “upper” and a lower side of the same is referred to as “lower” in the following descriptions.

[1] As shown in FIG. 1A, the first base member 21 and the second base member 22 are first prepared. Here, FIG. 1A does not show the second base member 22.

Though materials of the first base member 21 and the second base member are not limited, the first base member 21 and the second base member 22 may be made of, for example, polyolefins such as polyethylene, polypropylene, ethylene-propylene copolymer, ethylene-acrylic acid ester copolymer, ethylene-acrylic acid copolymer, polybutene-1, and ethylene-vinyl acetate copolymer (EVA); cyclic polyolefin; modified polyolefin; polyvinyl chloride; polyvinylidene chloride; polystyrene; polyamide; polyimide; polyamide-imide; polycarbonate; poly-(4-methylpentene-1); ionomer; acrylic resin; polymethyl methacrylate (PMMA); acrylonitrile-butadiene-styrene copolymer (ABS resin); acrylonitrile-styrene copolymer (AS resin); butadiene-styrene copolymer; polyoxymethylene, polyvinyl alcohol (PVA); ethylene-vinyl alcohol copolymer (EVOH); polyesters such as polyethylene terephthalate (PET), polyethylene naphthalate, polybutylene terephthalate (PBT), and polycyclohexyl terephthalate (PCT); polyether; polyetherketone (PEK); polyether ether ketone (PEEK); polyetherimide; polyacetal (polyoxymethylene: POM); polyphenyleneoxide; modified-polyphenyleneoxide; polysulfone; polyethersulfone; polyphenylene sulfide; polyarylate; aromatic polyester (liquid crystal polymer); polytetrafluoroethylene; polyvinylidene fluoride; other fluororesins; stylene-, polyolefin-, polyvinyl chloride-, polyurethane-, polyester-, polyamide-, polybutadiene-, trans-polyisoprene-, fluoro rubber-, and chlorinated polyethylene-thermosetting elastomers; resins such as epoxy resin, phenol resin, urea resin, melamine resin, aramid resin, unsaturated polyester, silicone resin, and polyurethane, or copolymers mainly containing these resins, polymer blends, or polymer alloys; metals such as Fe, Ni, Co, Cr, Mn, Zn, Pt, Au, Ag, Cu, Pd, Al, W, Ti, V, Mo, Nb, Zr, Pr, Nd, and Sm, an alloy of these metals; metallic materials such as carbon steel, stainless steel, indium-tin oxide (ITO), and gallium arsenide; silicon materials such as monocrystalline silicon, polycrystalline silicon, and amorphous silicon; glass materials such as silicate glass (silica glass), alkaline silicate glass, soda-lime glass, potash-lime glass, lead-alkali glass, barium glass, and borosilicate glass; ceramic materials such as alumina, zirconia, MgAl₂O₄, ferrite, silicon nitride, aluminum nitride, boron nitride, titanium nitride, silicon carbide, boron carbide, titanium carbide, and tungsten carbide; or carbon materials such as graphite. These materials may be used singly or used as a composite material including two or more.

A surface treatment may be performed on a surface of each of the first and second base members 21 and 22. The surface treatment may be a plating treatment such as Ni plating, a passivation treatment such as chromating, a nitriding treatment, or the like.

The first and second base members 21 and 22 may be made of the same material or different materials.

The first and second base members 21 and 22 preferably have thermal expansion coefficients which are approximately same as each other. When the first and second base members 21 and 22 having the approximately same thermal expansion coefficients are bonded to each other, stress caused by thermal expansion hardly occurs on a bonding interface. As a result, separation between the base members of the bonded body 1, which is finally obtained, can be securely prevented.

Even in a case where the thermal expansion coefficients of the first and second base members 21 and 22 are different from each other, the base members 21 and 22 can be firmly bonded to each other with high dimensional accuracy by optimizing a condition for bonding the base members 21 and 22 in a step which is described in detail later.

Further, the base members 21 and 22 preferably have different rigidity from each other. Accordingly, the base members 21 and 22 can be bonded to each other more firmly.

In addition, at least one of the base members 21 and 22 is preferably made of a resin material. Because of its flexibility, the resin material can reduce stress (for example, stress caused by thermal expansion) occurring on the bonding interface when the base members 21 and 22 are bonded to each other. Accordingly, the bonding interface is hardly damaged, being able to obtain the bonded body 1 in which the base members 21 and 22 are bonded to each other at high bonding strength.

According to the viewpoint described above, it is preferable that at least one of the base members 21 and 22 have flexibility. Accordingly, the bonding strength between the base members 21 and 22 that are bonded to each other with the bonding film 3 interposed can be further improved. In a case where the base members 21 and 22 both have flexibility, the whole of the bonded body 1 to be obtained has flexibility so as to be highly functional.

The base members 21 and 22 may have any shapes as long as they have a surface supporting the bonding film 3. For example, the base members may be plate-shaped (layer-shaped), block-shaped, or bar-shaped.

In the present embodiment, each of the base members 21 and 22 are plate-shaped as shown in FIGS. 1A to 2G. Accordingly, each of the base members 21 and 22 is easily bent. Therefore, when the base members 21 and 22 are superposed on each other, they are sufficiently deformed along each shape. Accordingly, adhesiveness between the base members 21 and 22 which are superposed is increased, enhancing the bonding strength between the base members 21 and 22 in the bonded body 1 which is finally obtained.

Additionally, flexion of each of the base members 21 and 22 can favorably reduce stress occurring on the bonding interface to some extent.

In this case, an average thickness of each of the base members 21 and 22 is not limited to a specific value, but preferably in a range approximately from 0.01 mm to 10 mm, and more preferably in a range approximately from 0.1 mm to 3 mm.

Next, a surface treatment is performed as necessary so as to increase adhesiveness with respect to the bonding film 3 to be formed on a bond surface 23 of the first base member 21. The bond surface 23 is cleaned and activated due to the surface treatment, whereby the bonding film 3 easily acts chemically on the bond surface 23. As a result, the bonding strength between the bond surface 23 and the bonding film 3 can be increased in a later described step in which the bonding film 3 is formed on the bond surface 23.

The surface treatment is not specifically limited, but may be a physical surface treatment such as sputtering and blast treatment; a chemical surface treatment such as a plasma treatment using oxygen plasma, nitrogen plasma, or the like, corona discharge, etching, electron beam irradiation, UV irradiation, and ozone exposure; or a combination of these treatments, for example.

In a case where the first base member 21 to which the surface treatment is to be performed is made of a resin material (a polymeric material), especially the corona discharge treatment, the nitrogen plasma treatment, or the like is preferably employed.

By employing the plasma treatment or the UV irradiation treatment performed as the surface treatment, the bond surface 23 can be further cleaned and activated. As a result, the bonding strength between the bond surface 23 and the bonding film 3 can be especially increased.

The first base member 21 made of some materials exhibits sufficiently high bonding strength with respect to the bonding film 3 even when the above surface treatment is not performed thereon. Examples of the materials exhibiting such the effect for the first base member 21 include materials mainly containing the various metal materials, the various silicone materials, or the various glass materials described above.

The first base member 21 made of any of the above materials has a surface covered with an oxide film having a hydroxyl group bonded (exposed) on the surface thereof. With the first base member 21 having the surface covered with the oxide film, the bonding strength between the bond surface 23 of the first base member 21 and the bonding film 3 can be increased even without performing the surface treatment as above.

In this case, the whole of the first base member 21 is not necessarily be made of any of the materials above. It is only necessary that at least a part of the first base member 21 around the bond surface 23 on which the bonding film 3 is to be formed is made of any of the materials.

Alternatively, an intermediate layer may be formed in advance on the bond surface 23 of the first base member 21, instead of performing the surface treatment.

The intermediate layer can have any function, but preferably has a function of increasing the adhesiveness with respect to the bonding film 3, a cushioning function (a buffer function), a function of reducing stress concentration, and the like, for example. The bonding film 3 is formed on such the intermediate layer, finally providing the bonded body 1 which is highly reliable.

Examples of a material for the intermediate layer include: metal materials such as aluminum and titanium; oxide materials such as metal oxide and silicon oxide; nitride materials such as metal nitride and silicon nitride; carbon materials such as graphite and diamond like carbon; self-assembled film materials such as a silane coupling agent, a thiol compound, metal alkoxide, and a metal-halogen compound; and resin materials such as resin adhesive, a resin film, a resin coating material, various rubber materials, and various elastomers. These materials may be used singly or used in a combined manner of two or more.

Among these materials, particularly, the intermediate layer made of the oxide materials can especially increase the bonding strength between the first base member 21 and the bonding film 3.

Meanwhile, similarly to the first base member 21, a surface treatment may be performed in advance on a bond surface 24 of the second base member 22 (a surface closely contacting with the bonding film 3 in a step described later), if necessary, so as to increase the adhesiveness with respect to the bonding film 3. The surface treatment cleans and activates the bond surface 24. As a result, the bonding strength between the bond surface 24 and the bonding film 3 can be increased in a later-described step in which the bond surface 24 is closely attached and bonded with the bonding film 3.

The surface treatment for the bond surface 24 is not specifically limited, but may be the same treatment as that performed on the bond surface 23 of the first base member 21 described above.

Similarly to the first base member 21, the second base member 22 made of some materials exhibits sufficiently high adhesiveness with respect to the bonding film 3 even when the surface treatment as above is not performed thereon. Examples of the materials exhibiting such the effect for the second base member 22 include materials mainly containing the various metal materials, the various silicon materials, and the various glass materials described above.

The second base member 22 made of any of the above materials has a surface covered with an oxide film having a hydroxyl group bonded to (exposed on) the surface thereof. When the second base member 22 having the surface covered with the oxide film is used, the bonding strength between the bond surface 24 of the second base member 22 and the bonding film 3 can be increased even without performing the surface treatment as above.

In this case, the whole of the second base member 22 is not necessarily be made of any of the above materials. It is only necessary that at least a part of the base member 22 around the bond surface 24 is made of any of the materials.

Further, when the bond surface 24 of the second base member 22 includes a group or a substance below, the bonding strength between the bond surface 24 of the second base member 22 and the bonding film 3 is sufficiently high even without the surface treatment described above.

The group or the substance is at least a single group or substance selected from the following groups and substances or a bonding hand which is linked to an atom and is not terminated because the following groups are cleaved, namely, a non-bonding hand (a dangling bond). The group or the substance is, for example, various functional groups such as a hydroxyl group, a thiol group, a carboxyl group, an amino group, a nitro group, and an imidazole group; various radicals; leaving intermediate molecules including a ring-opening molecule or an unsaturated bond such as double bonds and triple bonds; halogens such as F, Cl, Br, and I; or peroxide.

Among these, it is preferable that the leaving intermediate molecules be hydrocarbon molecules including the ring-opening molecule or the unsaturated bond. The hydrocarbon molecules strongly act on the bonding film 3 based on a significant reactivity of the ring-opening molecule and the unsaturated bond. Therefore, the bond surface 24 including such the hydrocarbon molecules can be strongly bonded to the bonding film 3.

Additionally, it is especially preferable that the functional groups included in the bond surface 24 be hydroxyl groups. Accordingly, the bond surface 24 can be especially easily and strongly bonded to the bonding film 3. Especially in a case where the hydroxyl groups are exposed on the surface of the bonding film 3, the bond surface 24 and the bonding film 3 can be strongly bonded in a short time based on a hydrogen bond occurring between the hydroxyl groups of the bond surface 24 and the bonding film 3.

A surface treatment arbitrarily selected from the various surface treatments mentioned above is performed on the bond surface 24 so as to allow the surface 24 to have such the group or the substance, thereby being able to obtain the second base member 22 which can be strongly bonded with the bonding film 3.

The bond surface 24 of the second base member 22 preferably includes the hydroxyl groups. On such the bond surface 24, large attraction force is generated based on the hydrogen bond with respect to the bonding film 3 on which the hydroxyl groups are exposed. Accordingly, the first base member 21 and the second base member 22 can be especially strongly bonded to each other finally.

Alternatively, a surface layer may be formed in advance on the bond surface 24 of the second base member 22, instead of performing the surface treatment.

The surface layer can have any function, and similarly to the first base member 21, preferably has a function of increasing the adhesiveness with respect to the bonding film 3, a cushioning function (a buffer function), a function of reducing stress concentration, and the like, for example. When the second base member 22 is bonded to the bonding film 3 with such the surface layer interposed, the bonded body 1 which is highly reliable can be finally obtained.

For example, the surface layer is made of the same material as that of the intermediate layer formed on the bond surface 23 of the first base member 21.

Note that the surface treatment and the formation of the surface layer as above can be performed according to need and can be omitted if especially large bonding strength is not particularly needed.

[2] A liquid material 35 containing a silicone material is applied on the bond surface 23 of the first base member 21. The liquid film 30 is thus formed on the first base member 21 as shown in FIG. 1B.

Examples of a method for applying the liquid material 35 on the bond surface 23 include immersing, droplet discharging (ink-jetting, for example), spin coating, doctor blade, bar coating, and painting with brush. These methods may be employed singly or in combination.

Though it varies depending on the applying method, a viscosity of the liquid material (at 25° C.) is commonly preferably in a range approximately from 0.5 mPa·s to 200 mPa·s, and more preferably in a reange approximately from 3 mPa·s to 20 mPa·s. With the liquid material 35 having the viscosity in the above range, the liquid film 30 having even film thickness can be easily formed. Further, the liquid material 35 having the viscosity in the above range contains the silicone material in an amount necessary and sufficient for forming the bonding film 3.

In a case where the droplet discharging is employed for applying the liquid material 35 having the viscosity in the above range to the bond surface 23, an amount of a droplet (an amount of a single droplet of the liquid material 35) can be set, specifically, in a range approximately from 0.1 pL to 40 pL on an average, and more practically in a range approximately from 1 pL to 30 pL. Accordingly, a landed diameter of a droplet 31 applied on the bond surface 23 is small, whereby even the bonding film 3 having a minute shape can be securely formed.

The liquid material 35 contains the silicone material as described above. However, when the silicone material itself is a liquid and has the viscosity in the above range, the silicone material as it is can be used as the liquid material 35. On the other hand, when the silicone material itself is a solid or a liquid having a high viscosity, a solution or a dispersion liquid of the silicone material may be used as the liquid material 35.

A solvent or a dispersion medium for dissolving or dispersing the silicone material may be: inorganic solvents such as ammonia, water, hydrogen peroxide, carbon tetrachloride, and ethylene carbonate; various organic solvents such as a ketone solvent such as methyl ethyl ketone (MEK) and acetone, an alcohol solvent such as methanol, ethanol, and isobutanol, an ether solvent such as diethyl ether and diisopropyl ether, a cellosolve solvent such as methyl cellosolve, an aliphatic hydrocarbon solvent such as hexane and pentane, an aromatic hydrocarbon compound solvent such as toluene, xylene, and benzene, an aromatic heterocyclic solvent such as pyridine, pyrazine, and furan, an amido solvent such as N,N-dimethylformamide (DMF); a halogen compound solvent such as dichloromethane and chloroform; an ester solvent such as ethyl acetate and methyl acetate, a sulfur compound solvent such as dimethylsulfoxide (DMSO) and sulfolane, a nitrile solvent such as acetonitrile, propionitrile, and acrylonitrile, an organic acid solvent such as formic acid and trifluoroacetic acid; or mixtures of these solvents.

The silicone material contained in the liquid material 35 is a main material of the bonding film 3 to be formed by drying the liquid material 35 in a step [3] below.

Here, the “silicone material” is a compound having a polyorganosiloxane skeleton. It usually is a compound having a main skeleton (a main chain) mainly formed by repeated organosiloxane units. It may have a branch structure in which a main chain is branched at a certain part thereof, may be a cyclic body of which a main chain is circularly formed, or may be a straight-chain body in which opposite terminals of a main chain are not linked to each other.

For example, in the compound having the polyorganosiloxane skeleton, the organosiloxane unit includes a structural unit expressed by the following general formula (1) at a terminal portion, a structural unit expressed by the following general formula (2) at a linking portion, and a structural unit expressed by the following general formula (3) at a branched portion.

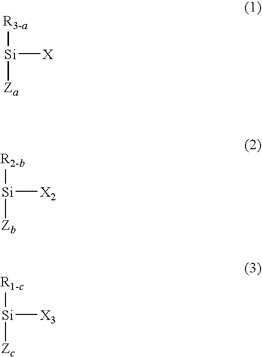

In the above formulas, each R independently represents a substituted or non-substituted hydrocarbon group; each Z independently represents a hydroxyl group or a hydrolytic group; each X represents a siloxane residue; each a represents 0 or an integer of 1, 2, or 3; each b represents 0 or an integer of 1 or 2; and each c represents 0 or 1.

The siloxane residue is bonded to a silicon atom included in an adjacent structure unit through an oxygen atom, and represents a substituent constituting a siloxane bond. Concretely, this structure is expressed as —O— (Si) (Si is a silicon atom included in an adjacent structure unit).

In the silicone material, the polyorganosiloxane skeleton preferably has a branched structure, that is, the skeleton is composed of the structural unit expressed by the general formula (1) above, the structural unit expressed by the general formula (2) above, and the structural unit expressed by the general formula (3). The compound having the branched polyorganosiloxane skeleton (hereinafter, also referred to as a “branched compound”) has a main skeleton (a main chain) mainly formed by repeated organosiloxane units, where the repetition of the organosiloxane units is branched at a certain part of the main chain and opposite terminals of the main chain are not linked to each other.

With the branched compound, the bonding film 3 is formed such that branch chains of the compound included in the liquid material 35 are entangled with each other in the step [3] below. Therefore, the bonding film 3 to be obtained especially has superior film strength.

In the above general formulas (1) to (3), examples of a group indicated by R (the substituted or the non-substituted hydrocarbon group) includes: alkyl groups such as a methyl group, an ethyl group, and a propyl group; cycloalkyl groups such as a cyclopentyl group and a cyclohexyl group; aryl groups such as a phenyl group, a tolyl group, and a biphenyl group; and aralkyl groups such as a benzyl group and a phenyl ethyl group. Further, the R may be a group in which a part of or all of hydrogen atoms bonded to carbon atoms of these groups is substituted by: halogen atoms such as a fluorine atom, a chlorine atom, and a bromine atom; epoxy groups such as a glycidoxy group; (meta)acrylyl groups such as a methacryl group; and anionic groups such as a carboxyl group, and a sulfonyl group, for example.

Examples of the hydrolytic group include: alkoxy groups such as a methoxy group, an ethoxy group, a propoxy group, and a butoxy group; ketoxime groups such as a dimethyl ketoxime group and a methylethyl ketoxime group; acyloxy groups such as an acetoxy group; and alkenyloxy groups such as an isopropenyloxy group and an isobutenyloxy group.

The branched compound preferably has a molecular weight in a range approximately from 1×10⁴ to 1×10⁶, and more preferably in a range approximately from 1×10⁵ to 1×10⁶. The viscosity of the liquid material 35 can be relatively easily set within the range described above by setting the molecular weight within the above range.

The branched compound as above preferably has a silanol group. Specifically, in the structural units expressed by the above general formulas (1) to (3), each group indicated by Z is preferably a hydroxyl group. Accordingly, in the following step [3] in which the liquid film 30 is dried so as to obtain the bonding film 3, hydroxyl groups, which are adjacent to each other, of the silanole groups included in the branched compound are bonded with each other. As a result, the bonding film 3 obtained has superior film strength. Further, as described above, when the first base member 21 having a hydroxyl group exposed on the bond surface (a main surface) 23 thereof is used, the hydroxyl group of the branched compound and the hydroxyl group of the first base member 21 are bonded with each other. Thus, the branched compound can be bonded to the first base member 21 both physically and chemically. As a result, the bonding film 3 is strongly bonded to the bond surface 23 of the first base member 21.

The hydrocarbon group linked to a silicon atom which constitutes the silanol group is preferably a phenyl group. Specifically, each group R in the structural units expressed by the above general formulas (1) to (3) each including the group Z as a hydroxyl group is preferably a phenyl group. Accordingly, reactivity of the silanol group is further improved, further facilitating bonding between the hydroxyl groups, which are adjacent to each other, of the branched compound.

Further, the hydrocarbon group linked to the silicon atom which does not constitute a silanol group is preferably a methyl group. Specifically, the group R included in the structural units expressed by the general formulas (1) to (3) having no group Z is preferably a methyl group. The compound including a methyl group as the group R included in the structural unit expressed by each of the general formulas (1) to (3) having no group Z is relatively easily available at low cost. Further, in the following step [4] in which plasma is brought into contact with the bonding film 3, the methyl group is easily cleaved, and as a result adhesiveness can be securely developed on the bonding film 3. Thus, the compound including a methyl group is preferably used as the branched compound (the silicone material).

Considering from the above, a compound expressed by the following general formula (4) is preferably used as the branched compound, for example.

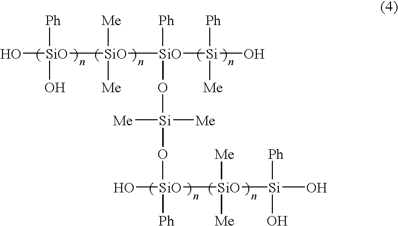

In the formula, n each independently represents 0 or an integer equal to or greater than 1.

In addition, the branched compound described above is a relatively flexible material. Therefore, in the following step [5] in which the second base member 22 is bonded to the first base member 21 with the bonding film 3 interposed therebetween so as to obtain the bonded body 1, stress caused by thermal expansion generated between the base members 21 and 22 can be securely reduced even if the first and second base members 21 and 22 are made of different materials, for example. Accordingly, in the bonded body 1 finally obtained, separation between the base members can be securely prevented.

Further, the branched compound has high chemical resistance, so that the branched compound can be effectively used to bond members which are exposed to chemicals or the like for a long period of time. Specifically, for example, in production of a droplet discharge head for an industrial ink-jet printer using an organic ink apt to erode a resin material, members are bonded to each other with the bonding film 3 interposed, reliably improving durability of the head. Furthermore, since the branched compound has high heat resistance, the branched compound can be effectively used to bond members which are exposed to a high temperature.

[3] The liquid material 35 applied on the first base member 21, that is, the liquid film 30 is dried, so as to form the bonding film 3 on the first base member 21 as shown in FIG. 1C.

A temperature for drying the liquid film 30 is preferably 25° C. or more, and more preferably approximately from 25° C. to 100° C.

Time for drying the liquid film 30 is preferably approximately from 0.5 hours to 48 hours, and more preferably approximately from 15 hours to 30 hours.

Drying the liquid film 30 under the above conditions can ensure formation of the bonding film 3 which obtains favorable adhesiveness developed thereon when the film 3 is brought into contact with plasma in the following step [4]. In a case where the silicone material including silanol groups described in the step [2] above is used, the silanol groups included in the silicone material can be securely bonded with each other, and further, the silanol group included in the silicone material and the hydroxyl group included in the first base member 21 can be securely bonded with each other. As a result, the bonding film 3 to be formed has superior film strength, and can be strongly boned to the first base member 21.

An ambient pressure in the drying step may be an atmospheric pressure, but preferably a reduced pressure. Specifically, a magnitude of the reduced pressure is preferably in a range approximately from 133.3×10⁻⁵ Pa to 1333 Pa (from 1×10⁻⁵ Torr to 10 Torr), and more preferably approximately from 133.3×10⁻⁴ Pa to 133.3 Pa (from 1×10⁻⁴ Torr to 1 Torr). Accordingly, layer density of the bonding film 3 is increased, that is, the bonding film 3 is densified so as to have superior film strength.

As described above, by arbitrarily setting the conditions for forming the bonding film 3, the bonding film 3 having desired film strength can be formed.

An average thickness of the bonding film 3 is preferably in a range approximately from 10 nm to 10,000 nm, and more preferably in a range approximately from 3000 nm to 6000 nm. Setting the average thickness of the bonding film 3 in the above range by arbitrarily determining an applying amount of the liquid material 35 can prevent a significant degradation in dimensional accuracy of the bonded body obtained by bonding the first and second base members 21 and 22, and also can ensure stronger bonding of the members.

When the average thickness of the bonding film 3 is smaller than the above range, sufficient bonding strength for bonding the first and second base members 21 and 22 can not be disadvantageously obtained. On the other hand, when the average thickness of the bonding film 3 is larger than the upper limit value of the above range, the dimensional accuracy of the bonded body may be significantly degraded disadvantageously.

Further, the bonding film 3 having an average thickness which is set within the above range is elastic to some extent. Accordingly, in the following step [5] in which the base members 21 and 22 are bonded with each other, even if a particle or the like adheres to the bond surface 24 of the second base member 22 to be brought into contact with the bonding film 3, the bonding film 3 is bonded to the bond surface 24 in a manner surrounding the particle or the like. This can appropriately suppress or prevent degradation in the bonding strength on an interface between the bonding film 3 and the bond surface 24 and separation occurring on the interface caused by the presence of the particle or the like.

In the embodiment, the bonding film 3 is formed by applying the liquid material 35. Accordingly, even if an uneven spot exists on the bond surface 23 of the first base member 21, the bonding film 3 can be formed so as to take up the uneven spot though depending on a height of the uneven spot. As a result, the bonding film 3 has a surface 32 which is nearly flat.

[4] Plasma is brought into contact with the surface 32 of the bonding film 3 formed on the bond surface 23.

When the plasma is brought into contact with the bonding film 3, part of molecular bonds particularly around the surface 32 is selectively cleaved in the bonding film 3, whereby the surface 32 is activated. As a result, adhesiveness with respect to the second base member 22 is developed around the surface 32.

The first base member 21 in such the state can be strongly bonded with the second base member 22 based on chemical bonding.

Here, in this specification, a state that the main surface 32 is “activated” is the following states: a state that part of molecular bonds on the surface 32 of the bonding film 3 is cleaved as described above, specifically, the methyl group included in a polydimethylsiloxane skeleton is cleaved, for example, and a bonding hand of an atom constituting the bonding film 3 is not terminated so as to produce a non-bonding hand (hereinafter, also referred to as a “dangling bond”) in the bonding film 3; a state that the non-bonding hand of the atom is terminated by the hydroxyl group (OH group); and a state that the above two states are mixed together.

Here, the following problems arise when ultraviolet light is used for activating the surface 32 of the bonding film 3 as the related art.

Long time (one minute to dozens of minutes, for example) is required for activating the surface 32 of the bonding film 3. Further, in a case of short-time irradiation of ultraviolet light, long time (dozens of minutes or more) is required for bonding the first base member 21 and the second base member 22 in the bonding step of the members. That is, long time is required for obtaining the bonded body 1.

Further, in a case using ultraviolet light, the ultraviolet light easily passes through the bonding film 3 in a thickness direction. Therefore, an interface (contacting face) between a member (the first base member 21 in the embodiment) and the bonding film 3 is deteriorated depending on a material (a resin material, for example) of the member, whereby the bonding film 3 is easily separated from the member.

The ultraviolet light acts on the whole of the bonding film 3 when passing through the bonding film 3 in the thickness direction, so that the methyl group included in the polydimethylsiloxane skeleton, for example, is cleaved and removed in the whole of the bonding film 3. Namely, an amount of an organic component in the bonding film 3 is excessively decreased and conversion of the bonding film 3 into an inorganic material proceeds. Accordingly, flexibility, which is produced by the organic component, of the bonding film 3 is degraded as a whole, so that intra-layer separation of the bonding film 3 easily occurs in the bonded body 1 to be obtained.

Further, in a case where the first base member 21 is separated from the second base member 22 so as to recycle or reuse each of the members 21 and 22 of the bonded body 1 which is obtained, the members 21 and 22 can be separated by applying separation energy to the bonded body 1. At this time, the methyl group (organic component) left in the bonding film 3 is cleaved and removed from the polydimethylsiloxane skeleton, for example, and the cleaved organic component becomes gas. The gas (gaseous organic component) produces cleavage in the bonding film 3 so as to split the bonding film 3.

However, the conversion of the whole of the bonding film 3 into an organic material progresses in a case of the ultraviolet light irradiation. Therefore, even if the separation energy is applied to the bonded body 1, extremely small amount of the organic component becomes gas, hardly producing cleavage in the bonding film 3.

In contrast, plasma is used for activating the surface 32 of the bonding film 3 in the embodiment. With the plasma, part of the molecular bonds of the material of the bonding film 3, for example the methyl group included in the polydimethylsiloxane skeleton is selectively cleaved around the surface 32 of the bonding film 3.

The cleaving of molecular bonds by plasma occurs by physical acting based on penning effect of the plasma as well as chemical acting based on electric charge of the plasma. Therefore, the cleaving occurs in extremely short time. Accordingly, the bonding film 3 can be activated in an extremely short period of time (a few seconds, for example). That is, the bonded body 1 can be manufactured in a short period of time.

Further, the plasma selectively acts on the surface 32 of the bonding film 3, and thus hardly affects on an inside of the bonding film 3. Therefore, the molecular bonds are selectively cleaved around the surface 32 of the bonding film 3. That is, a portion around the surface 32 of the bonding film 3 is selectively activated. Accordingly, disadvantages, described above, which arise in a case of activating the bonding film 3 with the ultraviolet light hardly arise.

As described above, the intra-layer separation of the bonding film 3 hardly occurs in the bonded body 1 in the case of using the plasma for activating the bonding film 3. Therefore, the first base member 21 can be reliably separated from the second base member 22 in the separation operation.

In the case activating the bonding film 3 by the ultraviolet light irradiation, an activating degree, which depends on an intensity of the ultraviolet light with which the bonding film 3 is irradiated, of the bonding film 3 enormously varies. Therefore, strict control of conditions for the ultraviolet light irradiation is required in order to activate the bonding film 3 to an extent suitable for bonding the first base member 21 and the second base member 22. When the conditions are not strictly controlled, the bonding strength between the first base member 21 and the second base member 22 varies between the bonded bodies 1 to be obtained.

On the other hand, in a case of activating the bonding film 3 by plasma, an activating degree, which depends on density of the plasma brought into contact with the bonding film 3, of the bonding film 3 moderately varies. Therefore, strict control of conditions for producing the plasma is not required for activating the bonding film 3 to an extent suitable for bonding the first base member 21 and the second base member 22. In other words, an acceptable range of the conditions for manufacturing the bonded body 1 is wide in a case where plasma is used for activating the bonding film 3. Further, even without the strict control of the conditions, the bonding strength between the first base member 21 and the second base member 22 hardly varies between the bonded bodies 1 to be obtained.

Further, the case of activating the bonding film 3 by the ultraviolet light irradiation has such a problem that the bonding film 3 in itself constricts (especially, the film thickness is decreased) as the bonding film 3 is activated, that is, as an organic substance in the bonding film 3 is eliminated. If the bonding film 3 constricts, it becomes difficult to bond the first base member 21 and the second base member 22 with high bonding strength.

On the other hand, in the case of activating the bonding film 3 with plasma, the portion around the surface of the bonding film 3 is selectively activated as described above, so that the bonding film 3 hardly constricts or does not constrict. Accordingly, even if the bonding film 3 is formed to have a relatively thin thickness, the first base member 21 and the second base member 22 can be bonded with each other at high bonding strength. In this case, such the bonded body 1 can be obtained that has high dimensional accuracy and is thinned.

As described above, the case of activating the bonding film 3 with plasma has more advantages than the case of activating the bonding film 3 with ultraviolet light.

Plasma can be brought into contact with the bonding film 3 in reduced pressure, but this is performed preferably in atmospheric pressure. Namely, the bonding film 3 is preferably treated by atmospheric-pressure plasma. According to the atmospheric-pressure plasma treatment, a surrounding area of the bonding film 3 is not in a reduced pressure state. Therefore, when the methyl group included in the polydimethylsiloxane skeleton, for example, is cleaved and removed (in the activation of the bonding film 3), the plasma acts to prevent unwanted progress of the cleaving.

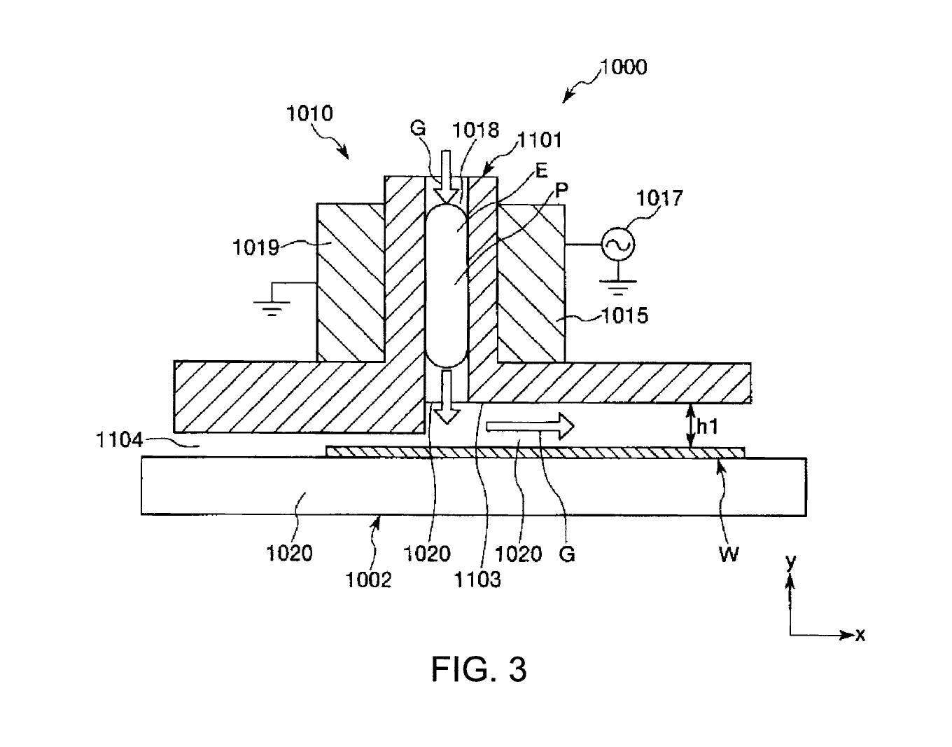

The plasma treatment in the atmospheric pressure can be performed with an atmospheric-pressure plasma treatment apparatus which is shown in FIG. 3, for example.

FIG. 3 is a schematic view showing a structure of an atmospheric-pressure plasma apparatus.

This atmospheric-pressure plasma apparatus 1000 shown in FIG. 3 includes a conveying device 1002 conveying the first base member 21 (hereinafter, referred to as merely a “treated substrate W”) on which the bonding film 3 is formed and a head 1010 disposed above the conveying device 1002.

In the atmospheric-pressure plasma device 1000, a plasma generation region P in which plasma is generated is formed between an applying electrode 1015 and a counter electrode 1019 that are included in the head 1010.

Hereinafter, a structure of each component will be described.

The conveying device 1002 includes a moving stage 1020 which is capable of carrying the treated substrate W. The moving stage 1020 can be moved in an x-axis direction by an operation of a moving unit (not shown) included in the conveying device 1002.

Here, the moving stage 1020 is made of, for example, a metal material such as stainless steel and aluminum.

The head 1010 includes a head body 1101, the applying electrode 1015, and the counter electrode 1019.

The head 1010 includes a gas supply flow path 1018 for supplying a treatment gas G, which is converted into plasma, to a gap 1102 which is formed between an upper surface of the moving stage 1020 (the conveying device 1002) and a lower surface 1103 of the head 1010.

The gas supply flow path 1018 is opened at an opening 1181 formed on the lower surface 1103 of the head 1010. Further, a step is formed at the left side of the lower surface 1103, as shown in FIG. 3. Accordingly, a gap formed between a left side portion, in the drawing, of the head body 1101 and the moving stage 1020 is smaller (narrower) than the gap 1102. As a result, entering of the treatment gas G, which is converted into plasma, to the gap 1104 is suppressed or prevented, so that the treatment gas G preferentially flows in an x-axis positive direction.

The head body 1101 is made of, for example, a dielectric material such as alumina and quartz.

In the head body 1101, the applying electrode 1015 and the counter electrode 1019 are disposed in an opposed manner so as to sandwich the gas supply flow path 1018, thus forming a pair of parallel plate electrodes. The applying electrode 1015 is electrically connected to a high frequency power supply 1017, and the counter electrode 1019 is grounded.

The applying electrode 1015 and the counter electrode 1019 are made of, for example, a metal material such as stainless steel and aluminum.

In a case of performing the plasma treatment on the treated substrate W with the atmospheric-pressure plasma apparatus 1000, a voltage is applied between the applying electrode 1015 and the counter electrode 1019 so as to generate an electric field E. In this state, the treatment gas G is permitted to flow into the gas supply flow path 1018. At this time, the treatment gas G flowing in the gas supply flow path 1018 discharges by acting of the electric field E so as to be converted into plasma. The treatment gas G which is converted into plasma is supplied into the gap 1102 from the opening 1181 formed on the lower surface 1103. Accordingly, the treatment gas G which is converted into plasma contacts with the surface 32 of the bonding film 3 formed on the treated substrate W. Thus the plasma treatment is performed.

With the atmospheric-pressure plasma apparatus 1000 as above, plasma can be easily and securely brought into contact with the bonding film 3 so as to be able to activate the bonding film 3.

Here, a distance between the applying electrode 1015 and the moving stage 1020 (the treated substrate W), that is, a height of the gap 1102 (a length denoted by h1 in FIG. 3) is arbitrarily determined in consideration of an output of the high frequency power supply 1017, a kind of the plasma treatment performed on the treated substrate W, and the like. However, the distance is preferably in a range approximately from 0.5 mm to 10 mm, and more preferably in a range approximately from 0.5 mm to 2 mm. Accordingly, the bonding film 3 can be securely activated by being brought into contact with plasma.

Further, the voltage applied between the applying voltage 1015 and the counter electrode 1019 is preferably in a range approximately from 1.0 kVp-p to 3.0 kVp-p, and more preferably in a range approximately from 1.0 kVp-p to 1.5 kVp-p. Accordingly, the electric field E can be more securely generated between the applying electrode 1015 and the counter electrode 1019 so as to securely convert the treatment gas G supplied to the gas supply flow path 1018 into plasma.

A frequency of the high frequency power supply 1017 is not limited, but is preferably in a range approximately from 10 MHz to 50 MHz, and more preferably in a range approximately from 10 MHz to 40 MHz.

The treatment gas G is not especially limited, but may be a rare gas such as helium gas and argon gas; or an oxygen gas, for example. These gases can be used singly or used in a combined manner of two or more. Among these, the treatment gas G is preferably a gas mainly containing a rare gas, and especially preferably a gas mainly containing the helium gas.

That is, plasma used for the treatment is preferably plasma obtained by converting a gas mainly containing helium gas. The gas mainly containing the helium gas (the treatment gas G) hardly generates ozone when converted into plasma, so that alteration (oxidation), caused by ozone, of the surface 32 of the bonding film 3 can be prevented. As a result, degradation of an activating degree of the bonding film 3 can be prevented, that is, the bonding film 3 can be securely activated. Further, plasma of the helium gas is favorably used from such a viewpoint that the plasma of the helium gas exhibits substantially high penning effect described above so as to be capable of securely activating the bonding film 3 in a short period of time.

In this case, a supplying speed of the gas mainly containing the helium gas to the gas supply flow path 1018 is preferably in a range approximately from 1 standard litter per minute (SLM) to 20 SLM, and more preferably in a range approximately from 5 SLM to 15 SLM. Accordingly, the activating degree of the bonding film 3 is easily controlled.

A contained amount of the helium gas in the gas (the treatment gas G) is preferably 85 vol % or more, and more preferably 90 vol % or more (can be 100%). Accordingly, the effect described above can be more markedly exhibited.

A moving speed of the moving stage 1020 is not especially limited, but is preferably in a range approximately from 1 mm/sec. to 20 mm/sec., and more preferably in a range approximately from 3 mm/sec. to 6 mm/sec. When plasma is brought into contact with the bonding film 3 at the speed in the above range, the bonding film 3 can be sufficiently and securely activated even in a short period of time.

[5] The first base member 21 and the second base member 22 are superposed in a manner closely attaching the bonding film 3 and the second base member 22 (refer to FIG. 2E). Since adhesiveness with respect to the second base member 22 is developed on the surface 32 of the bonding film 3 in the step [4] above, the bonding film 3 and the bond surface 24 of the second base member 22 are chemically bonded to each other. As a result, the first base member 21 and the second base member 22 are bonded to each other with the bonding film 3 interposed therebetween, whereby the bonded body 1 as shown in FIG. 2F is obtained.

The bonding method as this does not require a thermal treatment at high temperature (for example, 700° C. or higher), so that the first base member 21 and the second base member 22 even made of a material having low thermal resistance can be bonded together.

Since the first base member 21 and the second base member 22 are bonded to each other with the bonding film 3 interposed, a material of each of the base members 21 and 22 is not limited.

Accordingly, in the embodiment, a material of each of the first base member 21 and the second base member 22 has a wide range of choices.

In addition, in a case where the first base member 21 and the second base member 22 have different thermal expansion coefficients from each other, they are preferably bonded at as low temperature as possible. Bonding at a low temperature further reduces thermal stress occurring at a bonding interface.

Specifically, though it depends on a difference between the thermal expansion coefficients of the first base member 21 and the second base member 22, the first base member 21 and the second base member 22 are bonded with each other preferably under a state that a temperature of the first base member 21 and the second base member 22 is in a range approximately from 25° C. to 50° C., and more preferably in a range approximately from 25° C. to 40° C. With such the temperature range, even if a difference between the thermal expansion coefficients of the first base member 21 and the second base member 22 is large to some extent, thermal stress occurring at a bonding interface can be sufficiently reduced. As a result, warpage or separation occurring in the bonded body 1 can be reliably suppressed or prevented.

Here, in a case where a difference between the thermal expansion coefficients of the first base member 21 and the second base member 22 is specifically 5×10⁻⁵/K or more, the base members are especially recommended to be bonded at as low temperature as possible as described above.

Here, a mechanism of bonding the first base member 21 and the second base member 22 in the present step will be described.

As an example, a case where the hydroxyl groups are exposed on the bond surface 24 of the second base member 22 will be explained. In the present step, when the bonding film 3 formed on the first base member 21 and the bond surface 24 of the second base member 22 are superposed to contact with each other, the hydroxyl groups existing on the surface 32 of the bonding film 3 and the hydroxyl groups existing on the bond surface 24 of the second base member 22 attract each other by a hydrogen bond so as to generate attraction force between the hydroxyl groups. It is assumed that the first base member 21 and the second base member 22 are bonded with each other by this attraction force.

The hydroxyl groups attracting each other by the hydrogen bond are cleaved from the surfaces with dehydration condensation in accordance with a temperature condition and the like. As a result, at a bonding interface between the first base member 21 and the second base member 22, bonding hands, from which the hydroxyl groups are cleaved, on the surfaces are bonded with each other. Accordingly, the first base member 21 and the second base member 22 are more strongly bonded with each other presumably.

When bonding hands which are not terminated, namely, non-bonding hands (the dangling bonds) exist at the surface and the internal portion of the bonding film 3 of the first base member 21 and at the bond surface 24 and an internal portion of the second base member 22, these non-bonding hands are rebonded when the first base member 21 and the second base member 22 are bonded to each other. The non-bonding hands are complexly rebonded in a manner overlapped (intertangled) with each other, whereby a network-like bonds are formed on the bonding interface. Accordingly, the bonding film 3 and the second base member 22 are especially strongly bonded to each other.

The activated state of the surface of the bonding film 3 activated in the step [4] above temporally disappears. Therefore, the present step [5] is preferably performed as soon as possible after the completion of the previous step [4]. Specifically, the step [5] is preferably performed within 60 minutes after the completion of the step [4], and more preferably within 5 minutes. Within the time, the surface of the bonding film 3 sufficiently keeps the activated state. Therefore, when the first base member 21 and the second base member 22 are bonded together, sufficient bonding strength can be obtained between them.

In other words, the bonding film 3 before the activation is a bonding film obtained by drying the silicone material, so that it is relatively chemically stable and has excellent weather resistance. Accordingly, the bonding film 3 before the activation is suitable for a long term storage. Therefore, a large amount of the first base members 21 having such the bonding film 3 may be manufactured or purchased and stored. Then, immediately before the bonding of the present step, energy is applied only to a required number of the first base members 21 as described in the step [4] above. This is beneficial from viewpoints of manufacturing efficiency of the bonded body 1.

Thus, the bonded body (the bonded body of the invention) 1 shown in FIG. 2F can be obtained.

In the bonded body 1 thus formed, the bonding strength between the first base member 21 and the second base member 21 is preferably equal to or higher than 5 MPa (50 kgf/cm²), and more preferably equal to or higher than 10 MPa (100 kgf/cm²). In the bonded body 1 having such the bonding strength, separation between the base members can be sufficiently prevented. In addition, according to the bonding method of the embodiment, the bonded body 1 in which the first base member 21 and the second base member 22 are bonded with each other at the large bonding strength as mentioned above can be efficiently manufactured.

In addition, in a process of obtaining the bonded body 1 or after obtaining the bonded body 1, at least one step (a step for increasing bonding strength in the bonded body 1) out of two steps below (steps [6A] and [6B]) may be performed with respect to the bonded body 1 if necessary. Accordingly, the bonding strength in the bonded body 1 can be further improved with ease.

[6A] As shown in FIG. 2G, the bonded body 1 which is obtained is pressurized such that the first member 21 and the second member 22 come close to each other.

Accordingly, the surfaces of the bonding film 3 come closer to respective surfaces of the first base member 21 and the second base member 22, further increasing the bonding strength in the bonded body 1.

Additionally, gaps remaining at the bonding interface of the bonded body 1 are squashed by pressurizing the bonded body 1, whereby a bonding area can be further enlarged. Accordingly, the bonding strength in the bonded body 1 is further improved.

The pressure may be arbitrarily adjusted in accordance with conditions such as a material and a thickness of each of the first base member 21 and the second base member 22, and a bonding device. Specifically, though it slightly varies depending on the material and the thickness of each of the first base member 21 and the second base member 22, the pressure is preferably in a range approximately from 5 MPa to 60 MPa, and more preferably in a range approximately from 20 MPa to 50 MPa. Accordingly, the bonding strength in the bonded body 1 is reliably increased. The pressure may exceed the upper limit value of the above range. However, in this case, the first base member 21 and the second base member 22 may be damaged, for example, depending on the material thereof.

Pressurizing time is not particularly limited, but it is preferably in a range approximately from 10 seconds to 30 minutes. Here, the pressurizing time may be arbitrarily changed depending on pressure to be applied. Specifically, as the pressure applied on the bonded body 1 is increased, the bonding strength in the bonded body 1 can be improved even if the pressurizing time is shortened.

[6B] The bonded body 1 which is obtained is heated as shown in FIG. 2G.

Accordingly, the bonding strength in the bonded body 1 can be further improved.

A temperature for heating the bonded body 1 is not limited to a specific value as long as it is higher than room temperature and lower than a heat resistance temperature of the bonded body 1. However, the heating temperature is preferably in a range approximately from 25° C. to 100° C., and more preferably in a range approximately from 50° C. to 100° C. Heating at the temperature in the above range can securely prevent alteration and deterioration, caused by heat, of the bonded body 1 and also can securely improve the bonding strength.

The heating time is not particularly limited, but it is preferably in a range approximately from 1 minute to 30 minutes.

Here, in a case where the steps [6A] and [6B] are both performed, these steps are preferably performed at one time. That is, as shown in FIG. 2G, it is preferable that the bonded body 1 be heated while being pressurized. Accordingly, an effect of pressurizing and an effect of heating are synergistically exerted, whereby the bonding strength in the bonded body 1 is especially improved.

Through the above process, the bonding strength in the bonded body 1 is further improved with ease.

### Second Embodiment

A bonding method according to a second embodiment of the invention will now be described.

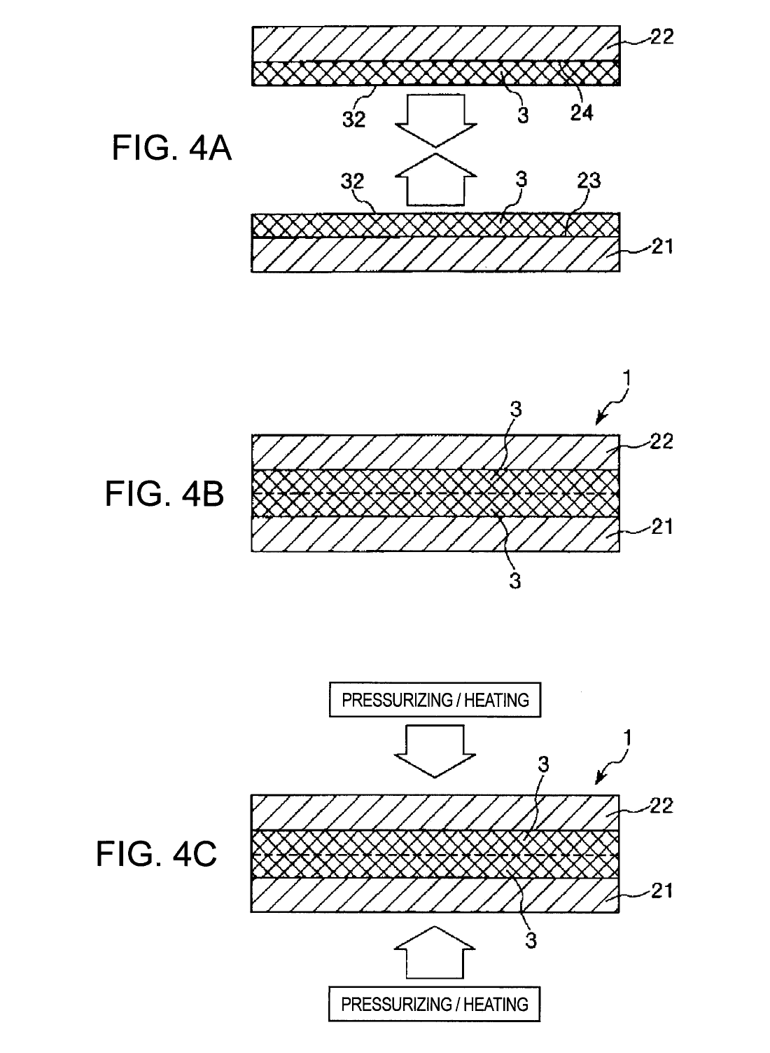

FIGS. 4A to 4C are longitudinal sectional views for illustrating the bonding method of the second embodiment. In the following description, the upper side in FIGS. 4A to 4C is described as “upper”, while the lower side is described as “lower”.

In the description of the bonding method of the second embodiment, points different from those in the bonding method of the first embodiment will be focused on and same points as in the first embodiment will be omitted.

In the bonding method according to the second embodiment, the bonding film 3 is formed not only on the bond surface (the surface) 23 of the first base member 21 but also on the bond surface (the surface) 24 of the second base member 22. Adhesiveness is developed around the surfaces 32 of the bonding films 3 provided to the base members 21 and 22 and the bonding films 3 are brought into contact with each other. Thus, the first base member 21 and the second base member 22 are bonded with each other, providing the bonded body 1. The bonding process except for the above is the same as that of the first embodiment.

That is, in the bonding method of the second embodiment, the bonding films 3 are respectively formed the first and second base members 21 and 22 and the bonding films 3 are integrated so as to bond the first and second base members 21 and 22.

[1′] A first base member 21 and a second base member 22 which are similar to those in the step [1] above are first prepared.

[2′] In a similar manner to the steps [2] and [3] above, the bonding films 3 are respectively formed on the bond surface 23 of the first base member 21 and the bond surface 24 of the second base member 22.

[3′] In a similar manner to the step [4] above, plasma is brought into contact with the bonding film 3 formed on the first base member 21 and the bonding film 3 formed on the second base member 22 so as to develop adhesiveness around the surface 32 of each of the bonding films 3.

[4′] As shown in FIG. 4A, the base members 21 and 22 are bonded with each other in a manner closely attaching the bonding films 3, on which adhesiveness is developed, of the base members 21 and 22 to each other. As a result, the base members 21 and 22 are bonded to each other by the bonding films 3 formed on the base members 21 and 22, whereby the bonded body 1 as shown in FIG. 4B is obtained.

Through the above process, the bonded body 1 can be obtained.

Here, after the bonded body 1 is obtained, at least one of the steps [6A] and [6C] of the first embodiment may be performed on the bonded body 1 if necessary.

For example, as shown in FIG. 4C, the bonded body 1 is heated and pressurized at one time, whereby the base members 21 and 22 of the bonded body 1 come closer to each other. This promotes dehydration condensation of hydroxyl groups and re-bonding between non-bonding hands on the interface between the bonding films 3. Consequently, the integration of the bonding films 3 is further progressed, and finally, the bonding films 3 are completely integrated.

In the first and second embodiments described above, the bonding film 3 is formed on the whole surface of one base member and each of the first and second base members 21 and 22, respectively. However, the bonding film 3 may be selectively formed on a part of one surface or parts of both surfaces of the first and second base members 21 and 22.

In this case, a region in which the first base member 21 and the second base member 22 are bonded with each other can be easily determined only by arbitrarily setting a size of a region on which the bonding film 3 is formed. Accordingly, the bonding strength in the bonded body 1 can be easily adjusted by controlling an area or a shape of the bonding film 3 at which the first and the second base members 21 and 22 are bonded, for example. Consequently, the bonded body 1 of which the bonding film 3 is easily separated, for example, can be obtained.

That is, the bonding strength in the bonded body 1 can be adjusted, and strength for splitting the bonded body 1 (splitting strength) can be adjusted at the same time.

In this regard, in manufacturing the bonded body 1 that can be easily split, the bonding strength in the bonded body 1 is preferably set to such an extent that the bonded body 1 can be easily split by human hands. Accordingly, the bonded body 1 can be easily split without using a device or the like.

Further, local concentration of stress occurring at the bonding film 3 can be reduced by arbitrarily setting an area and a shape of the bonding film 3 at which the first and the second base members 21 and 22 are bonded. Accordingly, even if a difference between the thermal expansion coefficients of the first base member 21 and the second base member 22 is large for example, the base members 21 and 22 can be securely bonded to each other.

Further, in this case, a space having a size (height) corresponding to the thickness of the bonding film 3 is formed between the first base member 21 and the second base member 22 in a region (film non-forming region) 42 in which the bonding film 3 is not formed. In order to utilize the space, a closed space or a flow path can be formed between the first base member 21 and the second base member 22 by arbitrarily adjusting a shape of the region on which the bonding film 3 is formed (film forming region).

Before plasma is brought into contact with the bonding films 3, a cross-linking treatment for cross-linking silicone materials constituting the bonding film 3 may be performed on the bonding film 3. This treatment can improve chemical resistance (solvent resistance) of the bonding film 3.

Such the bonding film 3 can be favorably used for bonding members constituting a product which stores compositions containing an organic solvent. Examples of the product include an ink-jet type recording head (droplet discharge head), which is described later, and the like.

Examples of the cross-linking treatment may include a heating treatment and a catalyst introducing treatment. They may be used singly or in combination.

Droplet Discharge Head

An ink-jet type recording head produced by applying the bonded body of any of the embodiments will be described.

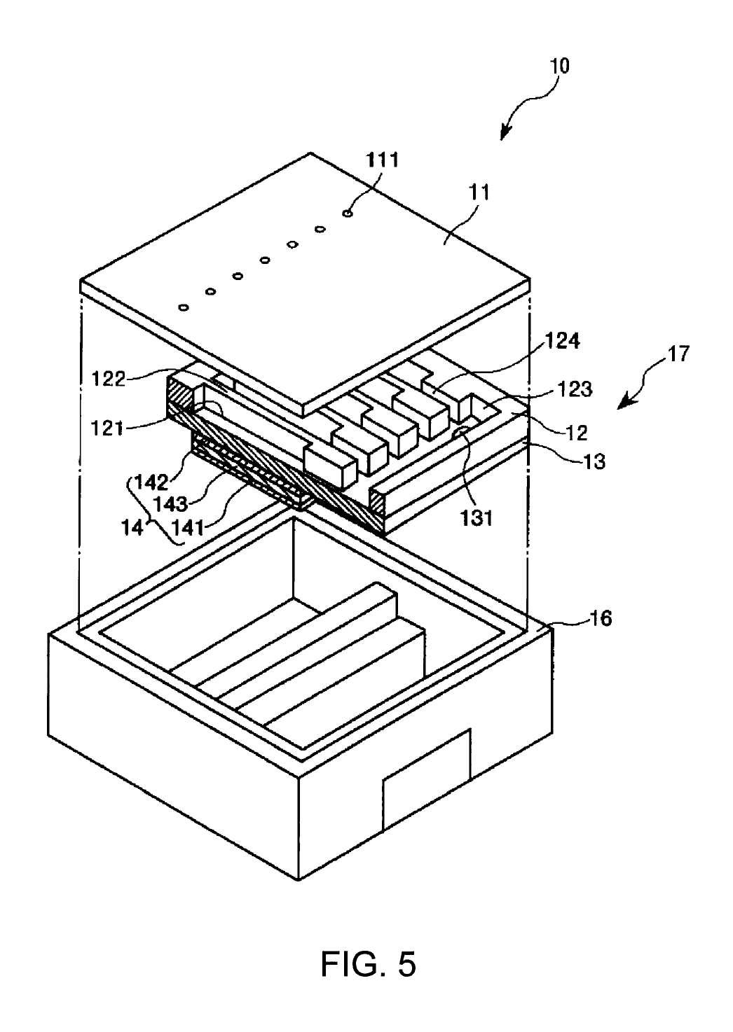

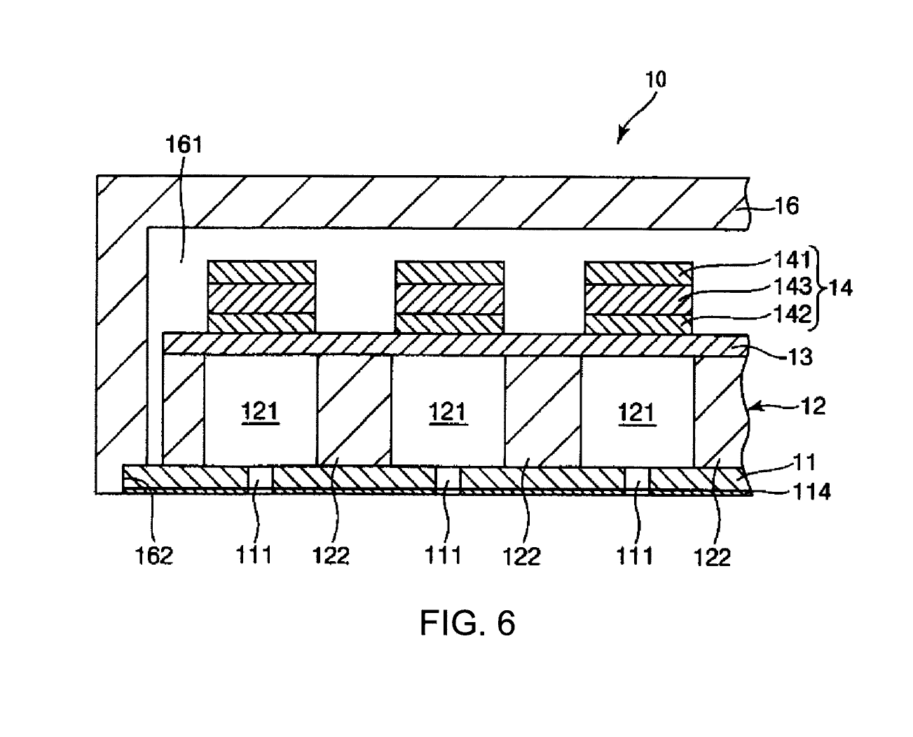

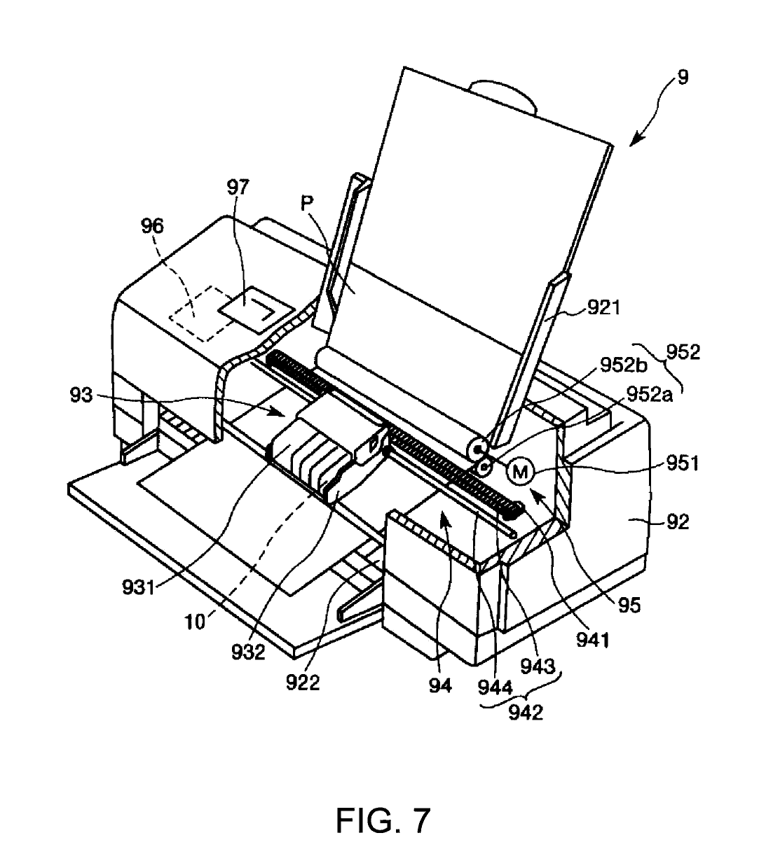

FIG. 5 is an exploded perspective view showing an ink-jet type recording head (a droplet discharge head) obtained by applying the bonded body of the embodiments. FIG. 6 is a sectional view showing a structure of a main part of the ink-jet type recording head of FIG. 5. FIG. 7 is a schematic view showing an ink-jet printer including the ink-jet type recording head of FIG. 5. In FIG. 5, the ink-jet type recording head is shown upside down relative to its normal operative position.

An ink-jet type recording head 10 shown in FIG. 5 is mounted on an ink-jet printer 9 as shown in FIG. 7.

The ink-jet printer 9 shown in FIG. 7 includes a device body 92; a tray 921 used for placing a record paper P thereon and disposed at an upper rear of the device body 92; a paper discharging port 922 used for discharging the record paper P and provided at a lower front of the device body 92; and an operation panel 97 provided on an upper surface of the device body 92.

For example, the operation panel 97 includes: a display section (not shown) composed of a liquid crystal display, an organic EL display, an LED lamp, or the like and displaying an error message and the like; and an operating section (not shown) composed of various kinds of switches and the like.

Inside the device body 92 are mainly provided a printing device (a printing unit) 94 having a reciprocating head unit 93, a paper feeding device (a paper feeding unit) 95 feeding each sheet of the record paper P into the printing device 94, and a controlling section (a controlling unit) 96 controlling the printing device 94 and the paper feeding device 95.

The controlling section 96 controls the paper feeding device 95 to intermittently feed each sheet of the recording paper P. The recording paper P passes through near a lower part of the head unit 93. During the passing of the record paper P, the head unit 93 reciprocates in a direction approximately orthogonal to a direction in which the record paper P is conveyed. Thus printing on the record paper P is performed. In short, ink-jet printing is performed in a manner that reciprocation of the head unit 93 and the intermittent feeding of the record paper P correspond to main scanning and sub-scanning respectively in a printing operation.

The printing device 94 includes the head unit 93, a carriage motor 941 as a driving source for the head unit 93, and a reciprocation mechanism 942 reciprocating the head unit 93 corresponding to rotation of the carriage motor 941.

At the lower part of the head unit 93 are provided an ink-jet type recording head 10 (hereinafter, referred to as merely a “head 10”) having a multitude of nozzle holes 111, an ink cartridge 931 supplying ink to the head 10, and a carriage 932 having the head 10 and the ink cartridge 931 mounted thereon.

Here, the ink cartridge 931 includes four color (yellow, cyan, magenta, and black) ink cartridges, enabling full-color printing.

The reciprocation mechanism 942 includes a carriage guiding shaft 944 having end portions supported by a frame (not shown) and a timing belt 943 extending in parallel with the carriage guiding shaft 944.

The carriage 932 is reciprocatably supported by the carriage guiding shaft 944 and fixed to a part of the timing belt 943.

When the timing belt 943 runs forward and backward via pulleys by an operation of the carriage motor 941, the head unit 93 reciprocates by a guide of the carriage guiding shaft 944. During the reciprocation, the head 10 arbitrarily discharges ink to perform printing on the record paper P.

The paper feeding device 95 includes a paper feeding motor 951 and a paper feeding roller 952 rotating in a manner to correspond to an operation of the paper feeding motor 951.

The paper feeding roller 952 is composed of a driven roller 952a and a driving roller 952b that are disposed at lower and upper positions to be opposed to each other in a manner to sandwich a feed channel for the record paper P (sandwiching the record paper P), and the driving roller 952b is coupled to the paper feeding motor 951. By this structure, the paper feeding roller 952 feeds each of multiple sheets of the record paper P set in the tray 921 toward the printing device 94. Here, instead of using the tray 921, a paper feeding cassette containing the record paper P may be removably attached.

The controlling section 96 controls the printing device 94, the paper feeding device 95, and the like based on printing data inputted from a host computer such as a personal computer and a digital camera so as to perform printing.

The controlling section 96 mainly includes a memory storing control programs for controlling respective sections and the like, a piezoelectric element driving circuit driving piezoelectric elements (a vibration source) 14 to control timing of discharging ink, a driving circuit driving the printing device 94 (the carriage motor 941), a driving circuit driving the paper feeding device 95 (the paper feeding motor 951), a communication circuit acquiring printing data from the host computer, and a CPU electrically connected to these components to perform various kinds of controls at the respective sections, although these components are not shown in the drawing.

In addition, the CPU is electrically coupled to various kinds of sensors, for example, capable of detecting an amount of ink left in each of the ink cartridges 931 and a position of the head unit 93, and the like.

The controlling section 96 acquires the printing data via the communication circuit to store the data in the memory. The CPU processes the printing data to output a driving signal to each of the driving circuits based on the processed data and input data inputted from the various sensors. The piezoelectric element 14, the printing device 94, and the paper feeding device 95 respectively operate based on the driving signal. Thus, the printing is performed on the record paper P.

Hereinafter, the head 10 will be described in detail with reference to FIGS. 5 and 6.

The head 10 includes a head main body 17 having a nozzle plate 11, an ink chamber substrate 12, a vibrating plate 13, and the piezoelectric elements (the vibration source) 14 bonded to the vibrating plate 13; and a base body 16 housing the head main body 17. The head 10 is an on-demand piezo-jet type head.

For example, the nozzle plate 11 may be made of a silicon material such as SiO₂, SiN, and quartz glass; a metal material such as Al, Fe, Ni, Cu, or an alloy of these metals; an oxide material such as alumina and iron oxide; a carbon material such as carbon black and graphite; or the like.

The nozzle plate 11 includes the multitude of nozzle holes 111 for discharging ink droplets. Pitches between the nozzle holes 111 are arbitrarily determined in accordance with printing precision.

The ink chamber substrate 12 is bonded (fixed) to the nozzle plate 11.

The ink cavity substrate 12 includes a plurality of ink chambers (cavities, pressure chambers) 121, a reservoir 123 storing ink supplied from the ink cartridge 931, and supply holes 124 respectively supplying the ink to the ink chambers 121 from the reservoir 123. The ink chambers 121, the reservoir 123, and the supply holes 124 are compartments formed by the nozzle plate 11, side walls (partition walls) 122, and the vibrating plate 13 described below.

Each of the ink chambers 121 is formed in a strip shape (a rectangular parallelepiped shape) and arranged corresponding to each of the nozzle holes 111. A bulk of the each of the ink chambers 121 can be changed by vibration of the vibrating plate 13 described below. The ink chamber 121 is configured so as to discharge ink by the bulk change thereof.

Examples of a base material for the ink chamber substrate 12 include silicon monocrystalline substrates, substrates made of various glasses, and substrates made of various resins. These substrates are all versatile. Accordingly, using any of these substrates can reduce manufacturing cost of the head 10.

The vibrating plate 13 is bonded to a side, which is opposite to a side facing the nozzle plate 11, of the ink chamber substrate 12, and the piezoelectric elements 14 are provided on a side, which is opposite to a side facing the ink chamber substrate 12, of the vibrating plate 13.

At a predetermined position of the vibrating plate 13, a through-hole 131 is formed in a manner penetrating through the vibrating plate 13 in a thickness direction of the plate 13. Via the through-hole 131, ink can be supplied to the reservoir 123 from the ink cartridge 931 described above.

Each of the piezoelectric elements 14 is composed of a lower electrode 142 and an upper electrode 141 with a piezoelectric layer 143 interposed therebetween, and disposed corresponding to an approximately center part of one of the ink chambers 121. Each of the piezoelectric elements 14 is electrically connected to the piezoelectric-element driving circuit to be operated (vibrated and deformed) in response to a signal from the piezoelectric-element driving circuit.

The piezoelectric element 14 serves as a vibrating source, and vibration of the piezoelectric element 14 allows the vibrating plate 13 to vibrate so as to momentarily increase internal pressure in the ink chamber 121.

The base body 16 is made of any of various resin materials and various metal materials, for example. The nozzle plate 11 is fixed to the base body 16 to be supported by the base body 16. Specifically, an edge portion of the nozzle plate 11 is supported by a stepped portion 162 formed at an outer periphery of a recessed portion 161 in a state that the head main body 17 is stored in the recessed portion 161 of the base body 16.

Among the bonding between the nozzle plate 11 and the ink chamber substrate 12, the bonding between the ink chamber substrate 12 and the vibrating plate 13, and the bonding between the nozzle plate 11 and the base body 16, at least one bonding is performed by using the bonding method of the embodiments.

In other words, the bonded body of any of the embodiments is applied to at least one among a bonded body of the nozzle plate 11 and the ink chamber substrate 12, a bonded body of the ink chamber substrate 12 and the vibrating plate 13, and a bonded body of the nozzle plate 11 and the base body 16.

The head 10 is formed such that substrates and the like are bonded with each other with the bonding film 3, as described above, interposed at the bonding interface. This increases bonding strength and chemical resistance of the bonding interface, thereby improving durability and liquid tightness with respect to ink stored in each of the ink chambers 121. As a result, the head 10 is formed to be highly reliable.

In addition, since a highly reliable bonding can be achieved at a very low temperature, there is an advantage that a large-area head can be obtained even by using materials having different linear expansion coefficients from each other.

Using the bonded body of the embodiments as a part of the head 10 allows the head 10 to have high dimensional accuracy. Therefore, a high level of control can be achieved over the discharging direction of ink discharged from the head 10 and a distance between the head 10 and the record paper P, thereby improving quality of a print result obtained by the ink-jet printer 9.

Further, a position on which the liquid material is applied can be arbitrarily set by employing the droplet discharging method. Therefore, local concentration of stress occurring at the bonding interface of each bonded body can be reduced by arbitrarily controlling an area or a position of a bonding part of the bonded body. Accordingly, even when thermal expansion coefficients are largely different in each pair of the nozzle plate 11 and the ink chamber substrate 12, the ink chamber substrate 12 and the vibrating plate 13, and the nozzle plate 11 and the base body 16, members of the each pair can be securely bonded to each other.

Further, reduce of the local concentration of stress occurring at the bonding interface can securely prevent separation in the bonded body or deformation (warpage) of the bonded body, for example. As a result, the head 10 and the ink-jet printer 9 having high reliability can be obtained.

In the head 10 thus formed, the piezoelectric layer 143 is not deformed in a state that a predetermined discharging signal is not inputted from the piezoelectric element driving circuit, namely in a state that no voltage is applied between the lower and upper electrodes 142 and 141 of the piezoelectric element 14. Accordingly, the vibrating plate 13 is not deformed, and therefore the bulk of the ink chamber 121 is not changed. Accordingly, no ink droplet is discharged from the nozzle hole 111.

On the other hand, the piezoelectric layer 143 is deformed in a state that a predetermined signal is inputted from the piezoelectric element driving circuit, namely in a state that a predetermined voltage is applied between the lower and upper electrodes 142 and 141 of the piezoelectric element 14. Accordingly, the vibrating plate 13 is largely bent, changing the bulk of the ink chamber 121. At this time, pressure inside the ink chamber 121 is momentarily increased, whereby ink droplets are discharged form the nozzle hole 111.

After completion of one-time ink discharging, the piezoelectric element driving circuit stops applying a voltage between the lower and upper electrodes 142 and 141. Thereby, the shape of the piezoelectric element 14 returns to an almost original shape, and thus, the bulk of the ink chamber 121 is increased. At this point, ink is in the influence of pressure directing from the ink cartridge 931 toward the nozzle hole 111 (pressure in a positive direction). This prevents entry of air from the nozzle hole 111 into the ink chamber 121, resulting in supply of ink, having an amount corresponding to an amount of ink to be discharged, to the ink chamber 121 from the ink cartridge 931 (the reservoir 123).

In this manner, in the head 10, a discharging signal is sequentially inputted into the piezoelectric element 14 located at an intended position for printing from the piezoelectric element driving circuit, being able to print arbitrary (desired) characters, figures, and the like.

Alternatively, the head 10 may include an electrothermal converting element instead of the piezoelectric element 14. That is, the head 10 may be a head of a bubble-jet (“bubble-jet” is a registered trademark) system using thermal expansion of a material by the electrothermal converting element.

In the head 10 structured as above, a coating film 114 is formed on the nozzle plate 11 so as to impart repellency. The coating film 114 can surely prevent ink droplets from being left around the nozzle hole 111 when the ink droplets are discharged from the nozzle hole 111. As a result, the ink droplets discharged from the nozzle hole 111 can be securely landed on an intended region.

Hereinabove, the bonding method and the bonded body of the invention have been described with reference to the drawings, but the invention is not limited to the embodiments.

For example, one or more of arbitrary steps may be added to the bonding method according to need.

Needless to say, the bonded body of the invention is applicable not only to the droplet discharge head but also to others. Specifically, the bonded body is applicable to a lens of an optical device, a semiconductor device, a microreactor, and the like.

### Working Example

Specific examples of the invention will now be described.

### Example 1

First, a monocrystalline silicon substrate and a glass substrate were prepared respectively as a first base member and a second base member, and a base treatment was performed on both of the substrates by oxygen plasma. Each of the substrates had a length of 20 mm, a width of 20 mm, and an average thickness of 1 mm.

Then a liquid material containing a silicone material having a polydimethylsiloxiane skeleton and containing toluene and isobutanol as a solvent (“KR-251” which is a product of Shin-Etsu Chemical Co., Ltd, and has a viscosity of 18.0 mPa·s at 25° C.) was prepared, and the liquid material was applied to the silicon substrate by spin coating so as to form a liquid film.

The liquid film was dried for 24 hours at the room temperature (25° C.) so as to form a bonding film (average thickness of approximately 3 μm) on the silicon substrate.

Subsequently, plasma was brought into contact with the bonding film, which had been formed on the silicon substrate, with the atmospheric-pressure plasma apparatus shown in FIG. 3 under the following conditions. Thereby the bonding film was activated and adhesiveness was developed on the surface of the film.

Conditions of Plasma Treatment

Treatment gas: helium gas
Gas supplying speed: 10 SLM
Distance between electrodes: 1 mm
Applied voltage: 1 kVp-p
Voltage frequency: 40 MHz
Moving speed: 5 mm/sec.

Then the silicon substrate and the glass substrate were superposed in a manner to bring a surface, with which the plasma had been brought into contact, of the bonding film into contact with a surface of the glass substrate.

Subsequently, the silicon substrate and the glass substrate were pressurized at 50 MPa at the room temperature (approximately 25° C.) and kept at the state for a minute. As a result, a bonded body was obtained that included the silicon substrate and the glass substrate bonded to each other with the bonding film interposed.

Bonding strength between the silicon substrate and the glass substrate of the bonded body was measured by using “Romulus” manufactured by Quad Group Inc., and as a result, the bonding strength was equal to or higher than 10 MPa.

### Example 2

A bonded body was obtained in a similar manner to Example 1 except for preparing a stainless-steel substrate instead of the singlecrystalline silicon substrate as the first substrate and preparing a polyimide substrate instead of the glass substrate as the second substrate.

A bonding strength between the stainless-steel substrate and the polyimide substrate of the bonded body was equal to or higher than 10 MPa in Example 2 as well.

### Example 3

A bonded body was obtained in a similar manner to Example 1 except for forming a bonding film on the glass substrate as well by employing the same method as that for forming the bonding film on the singlecrystalline silicon substrate, and bringing the bonding films formed on the substrates into contact with each other so as to bond the silicon substrate and the glass substrate with the bonding films interposed between the substrates.

A bonding strength between the silicon substrate and the glass substrate of the bonded body was equal to or higher than 10 MPa in Example 3 as well.

### Example 4

A bonded body was obtained in a similar manner to Example 1 except for using a liquid material containing the silicone material having the polydimethylsilixiane skeleton and no solvent (“KR-400” which is a product of Shin-Etsu Chemical Co., Ltd. and has a viscosity of 1.20 mPa·s at 25° C.).

A bonding strength between the silicon substrate and the glass substrate of the bonded body was equal to or higher than 10 MPa in Example 4 as well.

### Example 5

A bonded body was obtained in a similar manner to Example 1 except for using argon gas as the treatment gas.

A bonding strength between the silicon substrate and the glass substrate of the bonded body was equal to or higher than 10 MPa in Example 5 as well, but lower than that of Example 1.

### Example 6

A bonded body was obtained in a similar manner to Example 1 except for using mixed gas containing helium gas and oxygen gas as the treatment gas. Here, a contained amount of the helium gas in the mixed gas was 83 vol %.

A bonding strength between the silicon substrate and the glass substrate of the bonded body was equal to or higher than 10 MPa in Example 6 as well, but lower than that of Example 1 and further, lower then that of Example 5.

### Comparative Example

A bonded body was obtained in a similar manner to Example 1 except for performing ultraviolet light irradiation under the following conditions instead of performing the plasma treatment so as to activate a bonding film.

Conditions of Ultraviolet Light Irradiation

Composition of atmospheric gas: atmosphere (air)
Temperature of atmospheric gas: 20° C.
Pressure of atmospheric gas: atmospheric pressure (100 kPa)
Wavelength of ultraviolet light: 172 nm
Irradiation time with ultraviolet light: 900 seconds

In this Comparative Example, a bonding strength between the silicon substrate and the glass substrate in the bonded body was significantly lower than 5 MPa.

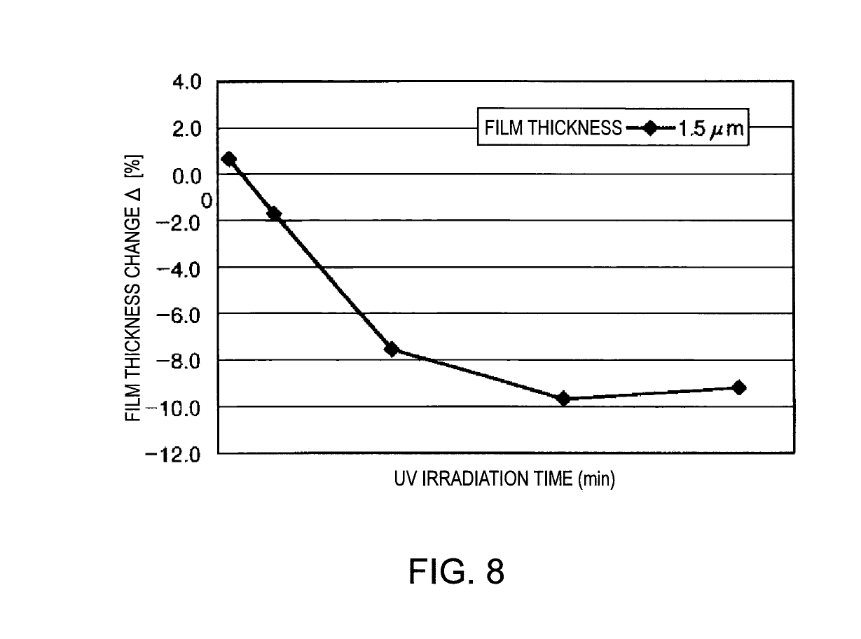

Here, another silicon substrate, which was not for obtaining a bonded body, was prepared, and a bonding film was formed on this silicon substrate (average thickness of approximately 3 μm). Then the bonding film which had been formed was irradiated with ultraviolet light described above for 50 minutes and a change of the thickness of the bonding film due to the UV irradiation was measured. FIG. 8 shows the measurement result.

As shown in FIG. 8, a changing rate of the film thickness due to the LTV irradiation was approximately −10%.

A changing rate of the film thickness of the bonding film in a case of plasma contact was also studied in a similar manner to the UV irradiation. As a result, the changing rate in the case of the plasma contact was smaller than that in the case of the LTV irradiation.

What is claimed is:

1. A bonding method, comprising:
a) applying a liquid material containing a silicone material to at least one of a first base member and a second base member so as to form a liquid film on the at least one of the base members;
b) drying the liquid film so as to obtain the bonding film on the at least one of the first base member and the second base member;
c) bringing plasma into contact with the bonding film so as to develop adhesiveness around a surface of the bonding film; and
d) bringing the first base member and the second base member into contact with each other in a manner to interpose the bonding film on which adhesiveness is developed therebetween so as to obtain a bonded body in which the first base member and the second base member are bonded to each other with the bonding film interposed therebetween.

2. The bonding method according to claim 1, wherein the plasma contact of the step c) is performed in atmospheric pressure.

3. The bonding method according to claim 1, wherein the plasma contact is performed such that a gas, the gas being converted into plasma by being introduced between electrodes opposed to each other in a state that a voltage is applied between the electrodes, is applied to the bonding film.

4. The bonding method according to claim 3, wherein a distance between the electrodes is from 0.5 mm to 10 mm inclusive.

5. The bonding method according to claim 3, wherein the voltage applied between the electrodes is from 1.0 kVp-p to 3.0 kVp-p inclusive.

6. The bonding method according to claim 1, wherein the plasma is obtained by converting a gas mainly containing a helium gas into plasma.

7. The bonding method according to claim 3, wherein the plasma is obtained by converting the gas mainly containing the helium gas into plasma, and an applying speed of the gas between the electrodes is from 1 standard litter per minute (SLM) to 20 SLM inclusive.

8. The bonding method according to claim 6, wherein a contained amount of the helium gas in the gas is 85 vol % or more.

9. The bonding method according to claim 1, wherein the silicone material has a polydimethylsiloxane skeleton as a main skeleton.

10. The bonding method according to claim 1, wherein the silicone material includes a silanol group.

11. The bonding method according to claim 1, wherein an average thickness of the bonding film is from 10 nm to 10,000 nm inclusive.

12. The bonding method according to claim 1, wherein at least a portion of the first base member and the second base member contacting with the bonding film is mainly made of one of a silicon material, a metal material, and a glass material.

13. The bonding method according to claim 1, wherein a surface treatment is performed on surfaces, the surfaces being to be brought into contact with the bonding film, of the first base member and the second base member in advance so as to increase the adhesiveness with respect to the bonding film.

14. The bonding method according to claim 13, wherein the surface treatment is one of a plasma treatment and an ultraviolet light irradiation treatment.

15. A bonded body obtained by bonding the first base member and the second base member with the bonding film interposed therebetween by the bonding method of claim 1.
